(19) United States
(12) Patent Application Publication
(10) Pub. No.: US 2005/0150587 A1
(43) Pub. Date: Jul. 14, 2005

(54) Tire building method and apparatus

(76) Inventor: John Wiens, Simpsonville, SC (US)

Correspondence Address: Michelin North America, Inc.;Intellectual Property Department, P.O. Box 2026, Greenville, SC, 29602, US

(21) Appl. No.: 11/076,494

(22) Filed: Mar. 8, 2005

(30) Foreign Application Priority Data
Sep. 12, 2002 (WO) PCT/US02/29136

(51) Int. Cl. B29D 30/32

(52) U.S. Cl. 156/132; 156/401; 156/415; 156/133

(57) ABSTRACT

A drum and a method of building a tire by the use of a unistage system is provided. The method includes the step of providing a drum that has a plurality of drum segments. A section of an outer surface of the drum is formed that has the same radial distance from the axial center of the drum. The drum has a plurality of bead gorges. Another step involves the application of a carcass reinforcement on the section of the outer surface of the drum that has the same radial distance from the axial center of the drum. At least one uncured rubber section is applied on the carcass reinforcement. The carcass reinforcement is wrapped around the uncured rubber section such that the orientation of the uncured rubber section remains the same.

### TECHNICAL FIELD

The present invention relates generally to a tire building apparatus and method for pneumatic tubeless tires.

### BACKGROUND

One design of a tire is illustrated in U.S. Pat. No. 5,891,279 that is owned by the assignee of the present invention and is incorporated by reference herein in its entirety for all purposes. Tire and rim assemblies of this type have a flexible elastomeric material in the shape of a ring disposed on the rim. The load of the vehicle and the dynamic load of the ride will then be borne by the elastomeric ring. With reasonable and appropriate response by the driver of the vehicle, such design can improve vehicle control during a sudden loss of air pressure and can help protect the rim and other components.

Certain tires may have a bead architecture that is different from conventional pneumatic tires. The bead architecture may be designed in such a way that upon a loss of air pressure to the tire, the beads grip the rim and retain the tire on the rim more than in normal conventional pneumatic tires.

The construction of a pneumatic tire often involves a two-stage process before the tread and lettering is imprinted into the tire. The first stage concerns the building of the beads and carcass of a tire on a drum. The tire is then moved to another drum in which the second stage of the tire building process occurs. Here, belts, an unfinished tire tread, and/or possibly sidewalls are added to the tire. However, it is also known in the art to provide for a single drum that allows for the combining of these two stages and the building of the afore-mentioned tire on the single drum. Such a process is typically known as a unistage building process because all of the steps prior to the addition of tread and/or lettering occurs on a single drum.

Previous methods of building this bead architecture may also suffer from variations in the precision and placement of an uncured rubber section in the bead during the manufacturing of tires.

The present invention improves upon previous building methods and drums used in building a tire by providing a method and a drum that is capable of producing a tire having a consistent tire bead architecture. Additionally, the present invention provides for a method and apparatus for building a tire that is a unistage method and a drum that is used in a unistage process.

### SUMMARY

Various features and advantages of the invention will be set forth in part in the following description, or may be obvious from the description, or may be learned through practice of the invention.

The present invention provides for a drum that is used in the building of a tire. The drum is provided with a plurality of drum segments that are disposed concentrically about the axial center of the drum. The plurality of drum segments form a section of an outer surface of the drum that has the same radial distance from the axial center of the drum. The plurality of drum segments are configured for moving in both the axial and radial direction of the drum. A plurality of bead gorges are present and engage the drum segments such that axial movement of the drum segments causes axial movement of the bead gorges. Also, radial movement of the drum segments causes radial movement of the bead gorges. The bead gorges are configured for receiving a bead complex during the production of the tire. Also, a plurality of turn-up bladders are located proximate to the drum segments. Expansion of the turn-up bladders aids in the production of the tire, and the turn-up bladders are configured so that an uncured rubber section is proximate to the bead gorge maintains the same orientation during the expansion and contraction of the turn-up bladder.

The present invention also includes a drum for use in the building of a tire as previously discussed where one bead gorge is in a first bead gorge configuration, and the other bead gorge is in a second bead gorge configuration.

The present invention also includes but is not limited to a method of building a tire. The method includes the step of providing a drum that has a plurality of drum segments. The drum segments form a section of an outer surface of the drum that has the same radial distance from the axial center of the drum. Additionally, the drum has a plurality of bead gorges. A carcass reinforcement is applied on the section of the outer surface of the drum that has the same radial distance from the axial center of the drum. At least one uncured rubber section is applied on the carcass reinforcement. The carcass reinforcement is wrapped around the uncured rubber section such that the orientation of the uncured rubber section remains the same.

The present invention also includes a method of building a tire as discussed above. The bead gorges are moved to a material lay position, and later the bead gorges are moved to a bead set position. A plurality of bead complexes are captured within the bead gorges so that the carcass reinforcement, the uncured rubber section, and the bead complexes form a plurality of beads. The bead gorges are moved to a shape position, and a tread complex engages the carcass reinforcement.

The present invention also includes a method of building a tire as discussed previously where an additional step of placing a plurality of bead complexes is included. The bead complexes have a bead apex and a bead wire and the bead complex is concentrically placed around the drum. The bead gorges and the bead complexes are moved radially relative to one another such that the bead complexes are captured in the bead gorges. The bead complexes and the uncured rubber section form beads of the tire.

The present invention also includes a method of building a tire as immediately discussed where the bead complexes are positioned at a predetermined location. The bead complexes are captured in the bead gorges in a predetermined position.

The present invention also includes a method of building a tire as previously discussed where the bead gorges are moved radially with respect to the bead complexes by a plurality of pneumatic drum expansion bladders.

The present invention also includes a method of building a tire as previously discussed where one bead gorge is in a first bead gorge configuration and the other bead gorge is in a second bead gorge configuration. A further exemplary embodiment exists in a method as immediately discussed where the second bead gorge configuration is deeper than the first bead gorge configuration.

### BRIEF DESCRIPTION OF THE DRAWINGS

FIG. 1 is a schematic representation of an exemplary embodiment of an apparatus for use in the building of a tire. This exemplary embodiment of a drum is shown in FIGS. 1-10 along with an exemplary embodiment of a method for building a tire by the use of a unistage system.

FIG. 2 is a schematic representation of the drum having an inner layer complex applied to the outer surface of the drum.

FIG. 3 is a schematic representation of the drum showing a carcass reinforcement being applied to the inner layer complex.

FIG. 4 is a schematic representation of the drum showing a plurality of bead complexes being concentrically placed around the drum and spaced from the carcass reinforcement.

FIG. 5 is a schematic representation of the drum showing a plurality of uncured rubber sections being placed on the carcass reinforcement.

FIG. 6 is a schematic representation of the drum showing a plurality of turn-up bladders being expanded in order to wrap the carcass reinforcement and the inner layer complex around the uncured rubber sections.

FIG. 7 is a schematic representation of the drum showing both the drum segments and the bead complexes being moved axially outward from the centerline of the drum.

FIG. 8 is a schematic representation of the drum showing the drum segments being radially expanded in order to capture the bead complexes and the uncured rubber sections into the bead gorges to form a bead.

FIG. 9 is a schematic representation of the drum showing sidewalls being attached to the beads and the carcass reinforcement.

FIG. 10 is a schematic representation of the drum showing the drum being pressurized and the bead gorges being moved axially inward such that the carcass reinforcement is attached to a tread complex.

FIG. 11 is a perspective view of a green tire. The green tire is formed by an exemplary embodiment of a method and/or apparatus in accordance with the present invention.

FIG. 12 is a detailed schematic representation of an uninflated turn-up bladder in accordance with the present invention.

### DETAILED DESCRIPTION

Reference will now be made in detail to exemplary embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

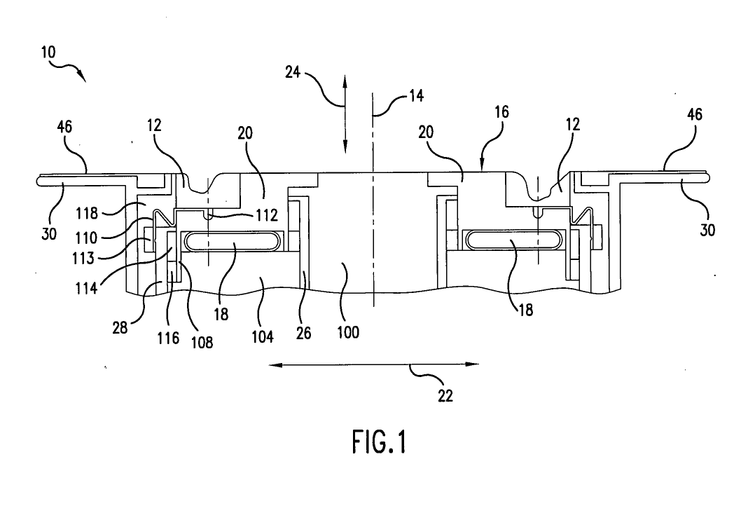

FIG. 1 shows an exemplary embodiment of a drum 10 for use in the building of a tire. The drum 10 includes a plurality of drum segments 20 located radially about the axial centerline (not shown) of the drum 10. The present invention encompasses any number of drum segments 20 used in order to form the drum 10. The drum 10 is substantially cylindrical in shape.

Each of the drum segments 20 includes a bead gorge 12 located on the outer surface of the drum segments 20. The bead gorge 12 may be a continuous annuler article that may be composed in one exemplary embodiment of poly-urethane. The bead gorge 12 includes a ring shaped insert with a recess disposed therein in order to help form the bead of the tire as will be discussed below. The bead gorge 12 may be removably attached to the drum segment 20 as is commonly known in the art. The drum segments 20 form a surface 16 that has a uniform radial distance from the axial center of the drum 10. In effect, this surface 16 can be thought of as the outer surface of a cylinder, the outer surface having the same diameter throughout. The bead gorges 12 are set to a “material lay position” in FIG. 1.

The drum 10 has a centerline 14 that is between drum segments 20. In one exemplary embodiment, the centerline 14 may be equal distant from both of the drum segments 20, while in other exemplary embodiments the drum segments 20 are at different distances to the centerline 14. The centerline 14 extends in the radial direction 24 of the drum 10. The drum 10 also has an axial direction 22 being perpendicular to the radial direction 24 in FIG. 1.

Located proximate to each drum segment 20 is a drum expansion bladder 18. The drum expansion bladder 18 may be a pneumatically operated expansion bladder. As shown in FIG. 1, the drum expansion bladder 18 is in an uninflated state. The purpose of the drum expansion bladder 18 is to move the drum segment 20 in the radial direction 24. In other exemplary embodiments of the present invention, the drum expansion bladder 18 may be substituted with other members that are capable of moving the drum segment 20 in the radial direction 24. For instance, hydraulic cylinders, kinematic linkages, or linear actuators may be used in place of the drum expansion bladder 18.

An inboard cover stop 26 and an outboard cover stop 28 are present within the drum 10 in order to limit the radial movement of the drum segments 20. The inboard and outboard cover stops 26 and 28 may also be used to properly position the drum segments 20 in a desired radial direction 24 through their function of limiting the radial movement of the drum segments 20. An open cavity 100 is present within the drum 10. The open cavity 100 allows for air to be communicated to the inside of a tire that is built on the drum 10 as will be explained below. Additionally, the open cavity 100 permits axial movement of the drum segments 20 in the axial direction 22.

A moveable housing 104 may be present in order to support the drum expansion bladder 18. The moveable housing 104 may be configured to move along with the drum segments 20. In one exemplary embodiment of the present invention, the moveable housing 104 may move axially during inflation of a tire that is formed on the drum 10.

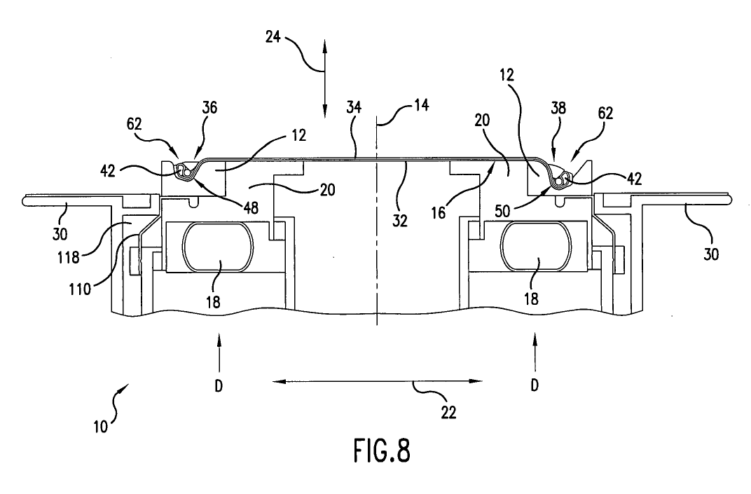

A key 116 may be present and be connected to the outboard cover stop 28. The key 116 may communicate with a lower portion or extension 108 of the drum segment 20. The key 116 may provide for radial stability during movement of the drum segment 20. A rubber seal 110 is provided that provides for an air seal of the drum 10 during times when the interior of the drum 10 is pressurized, for instance when air pressure is supplied to the open cavity 100. As can be seen in FIG. 8, the rubber seal 110 is extensible so that an air seal may be attained during various radial positions of the drum segment 20. An open cavity 118 may be present in order to accommodate the movement of the rubber seal 110. The rubber seal 110 may be secured on one end by a rubber seal attachment member 112 and on another end by a second rubber seal attachment member 113.

Referring back to FIG. 1, another open cavity 114 may be present within the drum 10 in order to accommodate for the movement in the radial direction of the key 116 and/or the lower portion or extension 108. Located proximate to each drum segment 20 is a bladder carrier 30. As shown in FIG. 1, an uninflated turn-up bladder 46 is present on the bladder carrier 30.

It is to be understood that the reference numerals shown on the left side of FIG. 1 correspond to elements that are present on the drum segment 20 on the right side of FIG. 1. Additionally, these elements are also present in the subsequent figures, but are not shown for sake of clarity. Additionally, other reference numerals may be included on one or more figures, but not included on other figures. Again, the omission of certain reference numerals in certain figures has been made for sake of clarity.

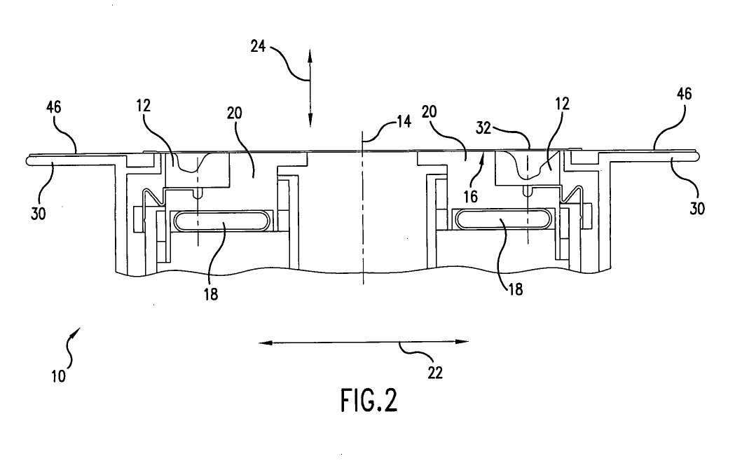

FIG. 2 shows the drum 10 of FIG. 1 having an inner layer complex 32 being applied to the outer surface 16 of the drum segments 20 and covering the bead gorges 12. The inner layer complex 32 is generally layered on the drum 10 to form a cylindrical shape. The outer edge of the inner layer complex 32 rests proximate to the bladder carrier 30 and the uninflated turn-up bladder 46. The inner layer complex 32 may therefore be a tube of material covering the drum 10. The inner layer complex 32 may be a member formed by two types of rubber or any other desired composite. It is advantageous in the building process to form these two types of rubber into the inner layer complex 32 before placing the two types of rubber onto the drum 10. However, as can be appreciated in other exemplary embodiments of the present invention, it may be desirable to have the two types of rubber formed directly on the drum 10 as opposed to being preformed into the inner layer complex 32. The inner layer complex 32 is composed of a type of rubber that forms the inner liner of the tire. This inner liner prevents air loss and forms the smooth surface on the inside of the tire. Additionally, a hard rubber protector layer (not shown) is also applied in order to form the inner layer complex 32. This hard rubber protector layer helps prevent the bead from becoming worn.

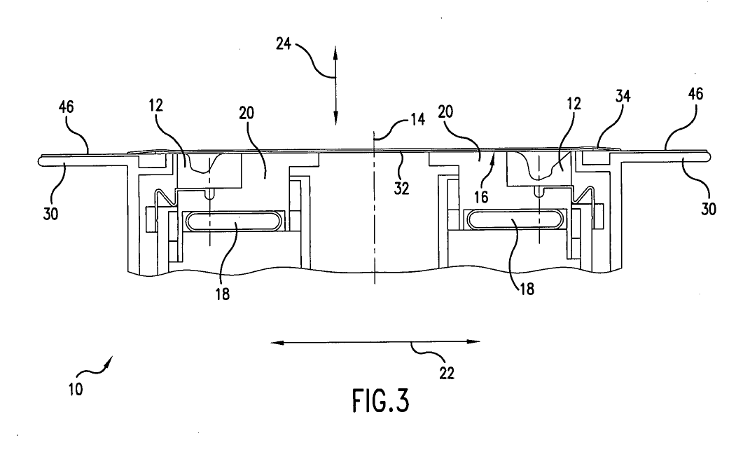

Referring now to FIG. 3, a carcass reinforcement 34 is next applied to the outside of the inner layer complex 32. The carcass reinforcement 34 extends over the inner layer complex 32 and onto an area proximate to the bladder carrier 30 and the uninflated turn-up bladders 46. The carcass reinforcement 34 may be extended around the entire drum 10. The carcass reinforcement 34 may be made of a series of layers of rubber and may be longer in the axial direction 22 than the inner layer complex 32. Additional reinforcements made of steel, textile, or other material may be dispersed throughout the carcass reinforcement 34. Various constructions of the carcass reinforcement 34 are known in the art and exemplary embodiments of the present invention encompass various configurations of the carcass reinforcement 34. For instance, U.S. Pat. No. 3,784,426, which is incorporated herein in its entirety for all purposes, discloses among other things one example of carcass reinforcements.

The carcass reinforcement 34 and the inner layer complex 32 in the uncured state are adhered to one another due to a “tackiness” that both materials exhibit. Both the carcass reinforcement 34 and the inner layer complex 32 are therefore adhered to one another upon contact and pressure. However, it may be the case that later processing of the tire causes the inner layer complex 32 and the carcass reinforcement 34 to exhibit a more permanent attachment to one another. The tackiness of the carcass reinforcement 34 allows for the retention of other elements that are applied to the drum 10 in order to form the tire. The inner layer complex 32 and the carcass reinforcement 34 may be automatically applied to the drum 10 in an exemplary embodiment of the present invention.

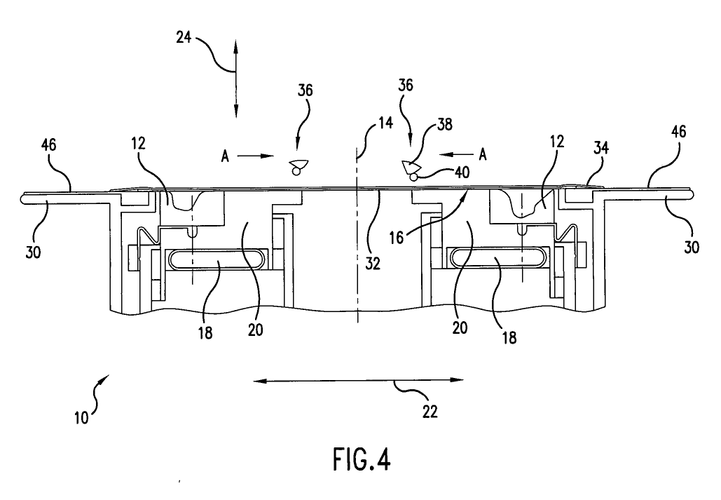

FIG. 4 shows another stage of the exemplary embodiment for forming a tire by a unistage building method. Here, a pair of bead complexes 36 are positioned concentrically about the axial center of the drum 10 and are spaced a distance from the carcass reinforcement 34. The bead complexes 36 may be of various cross-sections, and be in the form of a ring extending around the entire drum 10. The bead complexes 36 are moved axially into position by use of two bead carriers (not shown). Additionally, the bead complexes 36 may be positioned by other mechanical devices or by hand as is known in the art. The bead complex 36 is composed of a bead wire 40 and a bead apex 38. The bead wire 40 may be a single wire or a plurality of wires. The construction of such a bead wire 40 is well known in the art, and the present invention includes various configurations of the bead wire 40. The bead apex 38 is a type of rubber that is located immediately adjacent to the bead wire 40. As shown in FIG. 4, the bead complexes 36 have bead apexes 38 that are of different configurations. It may be the case that in other exemplary embodiments of the present invention, that the bead apexes 38 are identical to one another. The bead complexes 36 are moved in the direction of arrow A shown in FIG. 4 such that they are generally inbound of the drum segments 20 with respect to the centerline 14.

Additionally, the drum segments 20 may form a surface 16 that is essentially the same radial distance from the axial center of the drum 10 between both pairs of bead gorges 12. The drum segments 20 may be configured to move by a mechanical or pneumatic method or by other means known in the art as the drum segments 20 may be required to move as will be explained below.

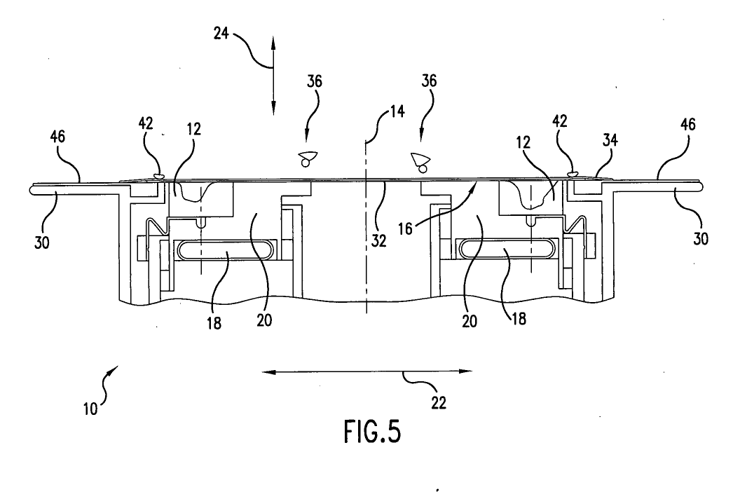

FIG. 5 shows a pair of uncured rubber sections 42 being placed on the carcass reinforcement 34 proximate to the bead gorges 12 and the bladder carriers 30. The uncured rubber section 42 may be of any cross-section and is in the shape of a ring extending around the drum 10. The uncured rubber section 42 may be positioned by a mechanical apparatus (not shown) or by hand as is commonly known in the art. Additionally, external guides (not shown) may be used to ensure the uncured rubber section 42 is properly positioned on the drum 10. In one exemplary embodiment of the present invention, the uncured rubber sections 42 may be an uncured rubber profile that is used to form the bead architecture of the tire. Although shown in the drawings as a quadrilateral shaped section, the uncured rubber section 42 may be formed in various shapes in other exemplary embodiments of the present invention. In one exemplary embodiment of the present invention, the uncured rubber section 42 is a compound having a Mooney ML (1+4) viscosity at 100 degrees centigrade, measured according to standard ASTM:D-1646, greater than or equal to 70. In addition, other hardnesses of the uncured rubber section 42 may be employed in other exemplary embodiments of the present invention.

The uninflated turn-up bladder 46 is shown in greater detail in FIG. 12. Here, the uninflated turn-up bladder 46 is shown being a double chamber bladder having a first chamber 130 and a second chamber 132 lying beneath the first chamber 130. The uninflated turn-up bladder 46 may surround the entire circumference of the drum 10. Other exemplary embodiments and configurations of the bladder 46 may be envisioned and used in accordance with the present invention.

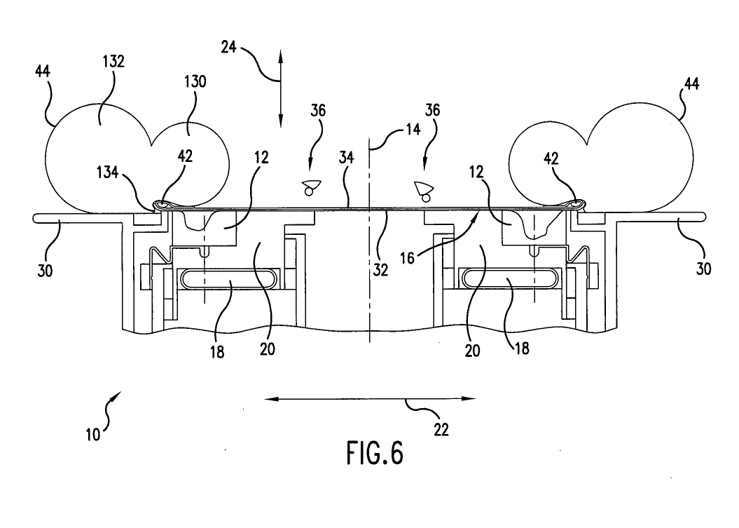

FIG. 6 shows the uninflated turn-up bladder 46 being inflated into an expanded turn-up bladder 44. In the exemplary embodiment shown in FIG. 6, the expansion of the expanded turn-up bladders 44 is effected by means of a pneumatic device (not shown) communicating with both of the expanded turn-up bladders 44. The expanded turn-up bladders 44 are configured in such a way that upon their expansion, they wrap the inner layer complex 32 and the carcass reinforcement 34 around the uncured rubber section 42.

Expanded turn-up bladders 44 are conventionally known in the art. Additionally, conventional double chamber turn-up bladders are known in the art. The expanded turn-up bladder 44 may be made of a first chamber 130 and a second chamber 132. The chambers 130 and 132 may be constructed so that they can expand separately or simultaneously with one another. In one exemplary embodiment, the first chamber 130 may be expanded first which forces the inner layer complex 32 and the carcass reinforcement 34 to be lifted and begin turning. The expanded turn-up bladder 44 has a hinge 134 at which point the first chamber will “flop over” the hinge 134 and be positioned basically on top of the uncured rubber section 42. Likewise, the inner layer complex 32 and the carcass reinforcement 34 will be moved into a vertical position and then folded over the uncured rubber section 42. The positioning of the hinge 134 is critical in ensuring that the expanded turn-up bladder 44 folds over the uncured rubber section 42 at the appropriate place and without rotating the uncured rubber section 42. The proper positioning of hinge 134 may be obtained through trial and error when setting up the drum 10. Such positioning may be obtained in as little as two or three trials in setting up the drum 10. Undue experimentation in not needed in determining this positioning. The positioning of the hinge 134 may be effected by moving the bladder carrier 30 with respect to the uncured rubber section 42 or the bead gorge 12. The second chamber 132 may be inflated to help urge the first chamber 130 over the uncured rubber section 42 to arrive at the positioning shown in FIG. 6. The expanded turn-up bladder 44 may be further inflated in order to push the inner layer complex 32 and the carcass reinforcement 34 onto itself and secured to itself due in part to the tacky nature of the uncured rubber of the carcass reinforcement 34. Therefore, pressure from the expanded turn-up bladder 44 applied onto the inner layer complex 32 and the carcass reinforcement 34 can also be used in order to effect a strong bond between these two layers.

The configuration of the expanded turn-up bladder 44 in operation ensures that the carcass reinforcement 34 and the inner layer complex 32 are wrapped around the uncured rubber section 42 such that the uncured rubber section 42 maintains the same orientation. In other words, the orientation of the uncured rubber section 42 with respect to the drum 10 does not change during the expansion of the expanded turn-up bladder 44 nor does it change during the wrapping of the carcass reinforcement 34 and the inner layer complex 32 around the uncured rubber section 42. Wrapping of the carcass reinforcement 34 and the inner layer complex 32 in this manner is advantageous in that the uncured rubber section 42 is positioned at a predetermined location throughout the wrapping process. Therefore, the uncured rubber section 42 can be knowingly positioned on the drum 10 and maintain this same position while the carcass reinforcement 34 and the inner layer complex 32 are manipulated. Therefore, this tire building method disclosed herein provides for a more consistent and robust design and manufacture of the bead portion of the tire. Having the uncured rubber section 42 consistently placed at a known position within the bead of the tire affords for the construction of a tire that exhibits more predictable properties and is structurally sound. An exemplary embodiment of the present invention is therefore directed to a tire that makes use of an uncured rubber section 42. Other tires may be constructed that do not have an uncured rubber section 42.

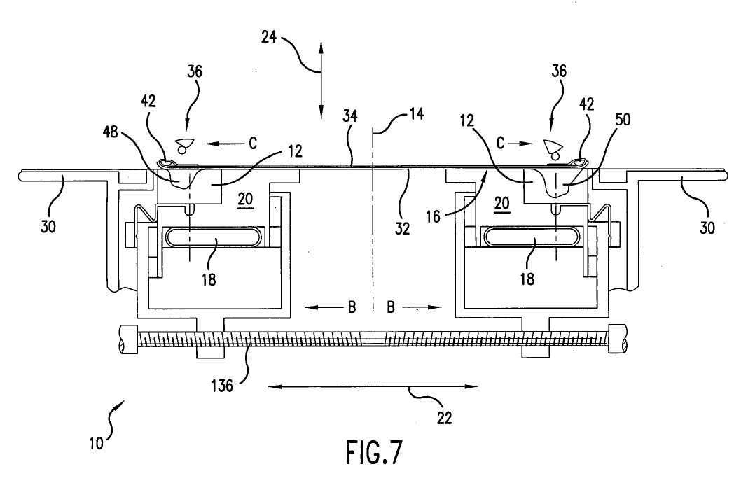

FIG. 7 shows the next stage in the production of a tire in accordance with the present invention. Here, the bead gorges 12 are moved in the axial direction 22 away from the centerline 14 of the drum 10. This movement is indicated by arrow B in FIG. 7. Expansion of the drum segments 20 causes the bead gorges 12 to expand. The bead gorges 12 are in a position in FIG. 7 known as the “bead set position”. The bead complexes 36 are also moved in the axial direction 22 away from the centerline 14 of the drum 10. This movement is indicated as arrow C. The bead complexes 36 are therefore moved into the bead set position in FIG. 7. The movement of the drum segments 20 and the bead complexes 36 may be simultaneous or one may move before the other in other exemplary embodiments of the present invention. It may be the case that upon moving the bead gorges 12 into the bead set position that the uncured rubber section 42 is supported by a portion of the bead gorge 12.

The movement of the drum segments 20 along with the bead gorges 12 in the axial direction 22 of the drum 10 may be effected by the use of a servo driven ballscrew 136 shown schematically in FIG. 7. When the drum 10 is rotated, the ballscrew servomotor (not shown) may be synchronized with the drum rotation motor (not shown) in order to maintain the distance required between the bead gorges 12. While a ballscrew 136 is shown, other ways of providing movement are possible in accordance with the present invention. For instance, the '426 patent shows a drive screw for accomplishing this movement.

As shown in FIG. 7, the bead gorges 12 each have a different configuration. A first bead gorge configuration 48 is present on one of the drum segments 20 and a second bead gorge configuration 50 is present on another of the drum segments 20. The first and second bead gorge configurations 48 and 50 are different in that the second bead gorge configuration 50 is deeper and has a slightly different cross-sectional profile than the first bead gorge configuration 48. The first and second bead gorge configurations 48 and 50 shown have uneven depths so that different beads 62 diameters may be produced. The resulting tire produced will therefore have bead complexes 36 of unequal diameters on either end of the tire. This may be necessary in part because of later assembly of the tire onto a wheel support rim. It may be the case that the tire is needed to clear an elastomeric ring or other portion of the rim on the outside of the wheel support rim. Having beads of different diameters and/or shapes may be necessary in order to provide for assembly at later stages in the build process, or may be done in order to provide for a functional advantage. Of course, other exemplary embodiments of the present invention may include bead gorges 12 where the first and second bead gorge configurations 48 and 50 are identical. The present invention encompasses various configurations of the first and second bead gorge configurations 48 and 50.

FIG. 8 shows the next step in the production of a tire using a unistage build construction. Here, the drum segments 20 are moved in the radial direction 24 away from the axial center of the drum 10. This movement is indicated by arrow D. The movement is effectuated by the expansion of the drum expansion bladders 18. The drum expansion bladders 18 are pneumatic bladders, but other means of expanding the drum segments 20 can be envisioned. The bead gorges 12 are therefore moved in the radial direction 24 along with the drum segments 20. The bead gorges 12 capture the uncured rubber section 42, the inner layer complex 32, the carcass reinforcement 34, and the bead complex 36 to form a bead 62.

The profile of the bead gorges 12 are designed so that they “wrap” the uncured rubber section 42 up onto the outside of the resulting bead 62. Since the uncured rubber section 42 was previously properly positioned, the step of forming the bead 62 can be accomplished such that the position of the uncured rubber section 42 within the bead 62 is consistently and knowingly determined. In addition, the orientation of the uncured rubber section 42 can be controlled by the profile of the bead gorges 12. Both the first bead gorge configuration 48 and the second bead gorge configuration 50 may be designed in order to wrap the uncured rubber section 42 onto the bead 62 in various ways. As can be seen in the drawings, the contour of the recesses of the bead gorge 12 may be matched to the shape of the bead apex 38 and/or the resulting bead 62. This may allow for a more advantageous formation in certain exemplary embodiments. As shown in FIG. 8, the first bead gorge configuration 48 forms a bead 62 that has a different configuration than the bead 62 formed by the second bead gorge configuration 50. These different bead configurations can be a result of either the profile of the bead gorges 12 or the shape of the bead complexes 36 or the shape of the uncured rubber sections 42. In other exemplary embodiments of the present invention, it may be the case that the bead complexes 36 and the uncured rubber sections 42 are moved into contact with the bead gorges 12 instead of having the bead gorges 12 contact the uncured rubber sections 42 and the bead complexes 36. In addition, in other exemplary embodiments of the present invention, both the bead gorges 12 and the uncured rubber sections 42 along with the bead complexes 36 may be moved.

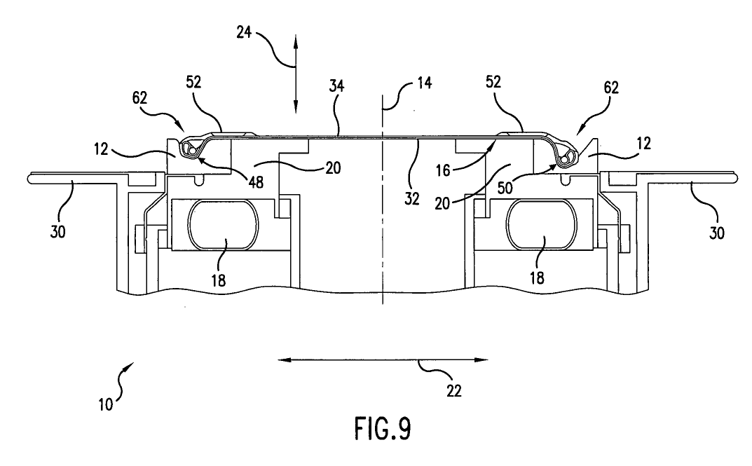

FIG. 9 shows the next step in the build process. Here, sidewalls 52 are applied to the carcass reinforcement 34 and the beads 62. The sidewalls 52 may be manually fitted onto the drum 10. Also, the sidewalls may be stitched together using a dynamic roller (not shown) that translates across the drum 10 as the drum 10 rotates. Rotation of the drum 10 may be effected by a servomotor (not shown).

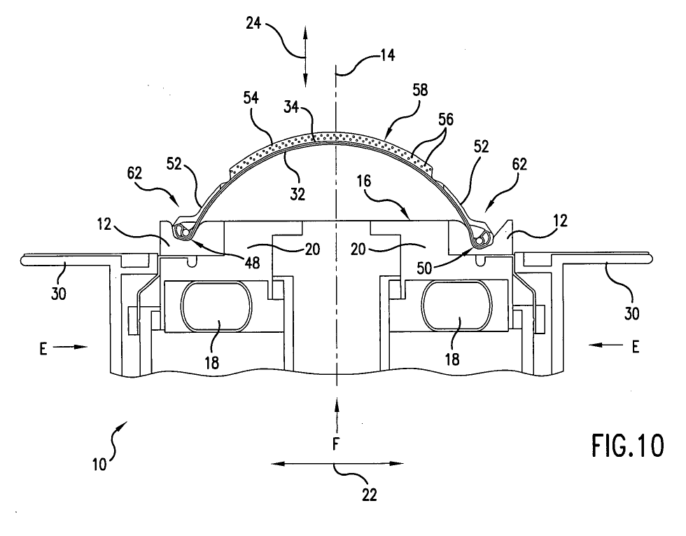

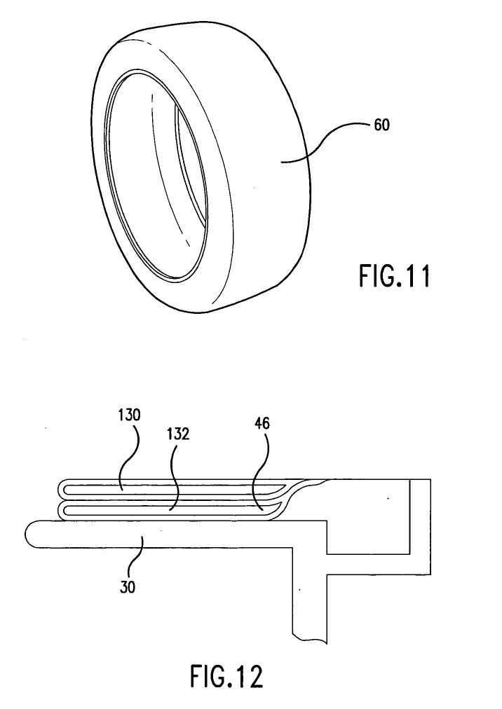

FIG. 9 shows the completion of the first stage of the building process. Other building processes known in the art then require the tire to be removed from the drum 10 and placed onto another drum for completion. The second stage of the building process is shown in FIG. 10 and in the unistage method may be combined with the first stage shown in FIGS. 1-9. However, in a unistage method, the tire is further constructed on this same drum 10. This further construction may be done by any method known in the art. For instance, FIG. 10 shows one example of how the tire may be completed using a unistage method. Here, a tread complex 58 is provided that is previously assembled with a tire tread 54 and a series of belts 56. Again, in other exemplary embodiments of the present invention, these parts may not be preassembled but may actually be formed on the drum 10 piece by piece. The tread complex 58 may be positioned by a T-ring (not shown) over the center of the drum 10. The drum 10 may then be pressurized such that the carcass reinforcement 34 has a pressure applied to it forcing it to move in the direction of arrow F. This pressurization of drum 10 may be accomplished by various means known in the art. At the same time the drum 10 is being pressurized, the drum segments 20 along with the bead gorges 12 are moved in the axial direction 22 of the drum 10 towards the centerline 14. They are moved into a “shape position” shown in FIG. 10. Upon the pressurization of the drum 10 and the movement of the bead gorges 12 into the shape position, the carcass reinforcement 34 contacts the inside of the tread complex 58 and the T-ring releases the tread complex 58. Again, the tackiness of the carcass reinforcement 34 helps to position the tread complex 58 onto itself. The tread complex 58 may then be stitched onto the carcass reinforcement 34 by the use of dynamic rollers that translate as the drum 10 rotates. When stitching is completed, the drum rotation ceases. The T-ring then grips the outside of the tire tread 54 and the drum 10 is depressurized. The drum 10 collapses allowing the T-ring to move laterally thus removing the finished green tire from the drum 10. The green tire 60 is shown in FIG. 11. At this point, the green tire 60 may be moved to a further process where tread is imprinted into the tire tread 54 and writing and other features are placed onto the green tire 60.

It should be understood that the present invention includes various modifications that can be made to the embodiments of the tire apparatus described herein as come within the scope of the appended claims and their equivalents.

1. A drum for use in building a tire, comprising:
a plurality of drum segments disposed concentrically about the axial center of said drum, said plurality of drum segments forming a section of an outer surface of said drum and having the same radial distance from the axial center of said drum, said plurality of drum segments configured for moving in the axial direction of said drum and configured for moving in the radial direction of said drum;
a plurality of bead gorges engaging said drum segments such that axial movement of said drum segments causes axial movement of said bead gorges and such that radial movement of said drum segments causes radial movement of said bead gorges, said bead gorges configured for receiving a bead complex during production of the tire; and
a plurality of turn-up bladders proximate to said drum segments, said turn-up bladders being configured such that an uncured rubber section proximate to said bead gorge maintains the same orientation during expansion and contraction of said turn-up bladder, wherein expansion of said turn-up bladders aids in the production of the tire.

2. The drum for use in building a tire of claim 1, wherein said drum segments are moved in the axial direction of said drum by a servo driven ballscrew.

3. The drum for use in building a tire of claim 1, wherein said drum is rotated by use of a servomotor.

4. The drum for use in building a tire of claim 1, wherein one of said bead gorges is in a first bead gorge configuration and the other of said bead gorges is in a second bead gorge configuration.

5. The drum for use in building a tire of claim 1, further comprising a plurality of pneumatic drum expansion bladders engaging said drum segments and being inflatable and deflatable to move said drum segments in the radial direction of said drum.

6. The drum for use in building a tire of claim 1, further comprising at least one bladder carrier located proximate to said drum segments, said turn-up bladders resting on said bladder carrier during the contracted state of said turn-up bladders.

7. The drum for use in building a tire of claim 1, wherein said turn-up bladders are positioned by bladder carriers such that said turn-up bladders wrap a portion of the tire around said uncured rubber section such that said uncured rubber section maintains the same orientation.

8. A method of building a tire comprising the steps of:
providing a drum having a plurality of drum segments disposed concentrically about the axial center of said drum, said plurality of drum segments forming a section of an outer surface of said drum having the same radial distance from the axial center of said drum, said drum segments having a plurality of bead gorges, said drum having a radial centerline;
applying an inner layer complex on said section of said outer surface and on said bead gorges;
applying a carcass reinforcement on said inner layer complex;
placing at least one bead complex having a bead apex and a bead wire concentrically around said drum and located axially inward from said bead gorges with respect to the radial centerline of said drum;
placing at least one uncured rubber section on said carcass reinforcement proximate to said bead gorges and axially outward from said bead complexes with respect to the radial centerline of said drum;
expanding at least one turn-up bladder to wrap said inner layer complex and said carcass reinforcement around said uncured rubber section such that the orientation of said uncured rubber section remains unchanged;
moving said drum segments axially outward with respect to the radial centerline of said drum;
moving said bead complexes axially outward with respect to the radial centerline of said drum; and
moving said drum segments radially outward from the axial center of said drum such that said bead complexes and said uncured rubber sections are captured by said bead gorges to form a plurality of beads.

9. The method of building a tire of claim 8, further comprising the steps of:
applying sidewalls on said beads and said carcass reinforcement; and
positioning a tread complex over said drum concentrically about and spaced from said carcass reinforcement.

10. The method of building a tire of claim 9, further comprising the steps of:
moving said drum segments axially inward with respect to the radial centerline of said drum;
pressurizing said drum such that said pressurization and axially inward movement of said drum segments causes said carcass reinforcement to contact said tread complex;
attaching said tread complex to said carcass reinforcement to form a green tire;
depressurizing said drum; and
removing said green tire from said drum.

11. A method of building a tire comprising the steps of:
providing a drum having a plurality of drum segments forming a section of an outer surface of said drum and having the same radial distance from the axial center of said drum, said drum having a plurality of bead gorges;
applying a carcass reinforcement on said section of said outer surface;
applying at least one uncured rubber section on said carcass reinforcement; and
wrapping said carcass reinforcement around said uncured rubber section such that the orientation of said uncured rubber section remains the same.

12. The method of building a tire of claim 11, wherein said carcass reinforcement is wrapped around said uncured rubber section by expansion of a plurality of turn-up bladders.

13. The method of building a tire of claim 11, further comprising the steps of:
placing a plurality of bead complexes having a bead apex and a bead wire concentrically around said drum; and
moving said bead gorges and said bead complexes radially relative to one another such that said bead complexes are captured in said bead gorges, said bead complexes and said uncured rubber section forming beads of said tire.

14. The method of building a tire of claim 13, wherein said bead gorges are moved radially with respect to said bead complexes by a plurality of pneumatic drum expansion bladders.

15. The method of building a tire of claim 11, further comprising the step of attaching sidewalls to said carcass reinforcement.

16. The method of building a tire of claim 11, wherein said drum segments are movable in the axial direction of said drum by a servo drive ballscrew.

17. The method of building a tire of claim 11, wherein said drum is rotatable by use of a servomotor.

18. The method of building a tire of claim 11, wherein one of said bead gorges is in a first bead gorge configuration and the other of said bead gorges is in a second bead gorge configuration.

19. The method of building a tire of claim 18, wherein said second bead gorge configuration is deeper than said first bead gorge configuration.

20. The method of building a tire of claim 15, further comprising the steps of:
placing a tread complex over said drum concentrically about and spaced from said carcass reinforcement;
engaging said tread complex with said carcass reinforcement; and
attaching said tread complex to said carcass reinforcement.

21. The method of building a tire of claim 13, wherein said bead complexes are positioned at a predetermined location and are captured in said bead gorges in a predetermined position.

22. The method of building a tire of claim 21, wherein the positioning of said bead complexes with respect to said uncured rubber section is predetermined.

23. A method of building a tire comprising the steps of:
providing a drum having a plurality of drum segments forming a section of an outer surface of said drum that has the same radial distance from the axial center of said drum, wherein said drum segments have a plurality of bead gorges;
moving said bead gorges to a material lay position;
applying a carcass reinforcement on said section of said outer surface;
applying at least one uncured rubber section on said carcass reinforcement;
wrapping said carcass reinforcement around said uncured rubber section such that the orientation of said uncured rubber section remains the same;
moving said bead gorges to a bead set position;
capturing a plurality of bead complexes within said bead gorges such that said carcass reinforcement, said uncured rubber section, and said bead complexes form a plurality of beads;
moving said bead gorges to a shape position; and
engaging a tread complex with said carcass reinforcement.
